(19) United States
(12) Patent Application Publication
(10) Pub. No.: US 2026/0162896 A1
(43) Pub. Date: Jun. 11, 2026

(54) MULTILAYER CERAMIC ELECTRONIC DEVICE AND DIELECTRIC CERAMIC COMPOSITION

(71) Applicant: TAIYO YUDEN CO., LTD., Tokyo (JP)

(72) Inventor: Tetsuo SHIMURA, Takasaki-shi (JP)

(21) Appl. No.: 19/393,062

(22) Filed: Nov. 18, 2025

(30) Foreign Application Priority Data
Dec. 11, 2024 (JP) 2024-216888

(51) Int. Cl. H01G 4/12; C04B 35/468; C04B 37/00; H01G 4/30

(52) U.S. Cl. CPC H01G 4/1209; C04B 35/4682; C04B 37/001; H01G 4/30; C04B 2235/3225; C04B 2235/3236; C04B 2235/3418; C04B 2235/87; C04B 2237/346; C04B 2237/68

(57) ABSTRACT

A multilayer ceramic electronic device includes a dielectric layer which includes a plurality of dielectric grains each of which includes a first rare earth element which is at least one selected from lanthanum, cerium, praseodymium, neodymium, promethium, samarium, europium or gadolinium and a second rare earth element which is at least one selected from yttrium, scandium, holmium, erbium, thulium, ytterbium or lutetium, in which an elemental ratio of the first rare earth element and the second rare earth element is from 65:35 to 35:65, and segregated phases mainly composed of silicon oxide are located at least one grain boundary triple point of the plurality of dielectric grains, a plurality of internal electrode layers which sandwich the dielectric layer and face each other, and external electrodes each of which is electrically connected to each of the plurality of internal electrode layers.

### CROSS-REFERENCE TO RELATED APPLICATION

This application is based upon and claims the benefit of priority of the prior Japanese Patent Application No. 2024-216888, filed on Dec. 11, 2024, the entire contents of which are incorporated herein by reference.

### FIELD

A certain aspect of the present disclosure relates to a multilayer ceramic electronic device and a dielectric ceramic composition.

### BACKGROUND

In recent years, multilayer ceramic electronic devices such as multilayer ceramic capacitors have increasingly been used in applications such as large-scale data centers and automotive power systems, where operation is expected to occur at high voltages of up to 100V. As a result, there is a growing need to ensure reliability under high voltages in the materials that make up these devices.

### SUMMARY OF THE INVENTION

According to an aspect of the embodiments, there is provided a multilayer ceramic electronic device including: a dielectric layer which includes a plurality of dielectric grains each of which includes a first rare earth element which is at least one selected from lanthanum, cerium, praseodymium, neodymium, promethium, samarium, europium or gadolinium and a second rare earth element which is at least one selected from yttrium, scandium, holmium, erbium, thulium, ytterbium or lutetium, in which an elemental ratio of the first rare earth element and the second rare earth element is from 65:35 to 35:65, and segregated phases mainly composed of silicon oxide are located at least one grain boundary triple point of the plurality of dielectric grains; a plurality of internal electrode layers which sandwich the dielectric layer and face each other; and external electrodes each of which is electrically connected to each of the plurality of internal electrode layers.

According to another aspect of the embodiments, there is provided a dielectric ceramic composition including: a plurality of dielectric grains each of which includes a first rare earth element which is at least one selected from lanthanum, cerium, praseodymium, neodymium, promethium, samarium, europium or gadolinium and a second rare earth element which is at least one selected from yttrium, scandium, holmium, erbium, thulium, ytterbium or lutetium, wherein an elemental ratio of the first rare earth element and the second rare earth element is from 65:35 to 35:65, and wherein segregated phases mainly composed of silicon oxide are located at least one grain boundary triple point of the plurality of dielectric grains.

### BRIEF DESCRIPTION OF THE DRAWINGS

FIG. 1 is a partial cross-sectional perspective view of a multilayer ceramic capacitor;

FIG. 2 is a cross-sectional view taken along line A-A in FIG. 1;

FIG. 3 is a cross-sectional view taken along line B-B in FIG. 1;

FIG. 4A and FIG. 4B are enlarged cross-sectional views of vicinity of external electrodes;

FIG. 5 illustrates a schematic cross sectional view of a dielectric layer;

FIG. 6 illustrates an enlarged cross sectional view around a dielectric grain;

FIG. 7 illustrates a flow of a manufacturing method of a multilayer ceramic capacitor;

FIG. 8A and FIG. 8B illustrate a printing process;

FIG. 9 illustrates a crimping process;

FIG. 10 is a diagram tracing a BSE image of a sample of Example 1;

FIG. 11 is a diagram tracing a BSE image of a sample of Comparative Example 1;

FIG. 12 is a diagram tracing a BSE image of a sample of Comparative Example 2;

FIG. 13 is a diagram of a result of a reliability test of Example 1;

FIG. 14 is a diagram of a result of a reliability test of Comparative Example 1; and

FIG. 15 is a diagram of a result of a reliability test of Comparative Example 2.

### DETAILED DESCRIPTION

For example, one method is to ensure reliability by reducing the concentration of oxide ion O²⁻ vacancies in the crystal lattice, which is thought to be the main factor determining the high-voltage reliability of multilayer ceramic electronic devices, as much as possible after sintering. This slows the rate at which vacancies accumulate at the electrode interface when voltage is applied.

When using a metal less noble than hydrogen, such as nickel, as the metal for the internal electrode layers, a sintering process in a reducing atmosphere is required to prevent oxidation of the electrode metal. However, for example, in multilayer ceramic electronic devices whose main component is the ferroelectric barium titanate to ensure high capacitance, titanium ions Ti⁴⁺ are partially reduced to Ti³⁺ in a reducing atmosphere, creating oxide ion vacancies to maintain the electrical neutrality of the entire oxide. Therefore, there is a limit to how much the concentration of oxide ion vacancies can be reduced after sintering. Oxide ion vacancies migrate due to the internal electric field when voltage is applied and ultimately accumulate at the interface between the internal electrode layer and the dielectric layer. As this accumulation progresses, electrical resistance at the interface is lost, leading to a loss of electrical reliability for the entire multilayer ceramic electronic device.

Hereinafter, an exemplary embodiment will be described with reference to the accompanying drawings.

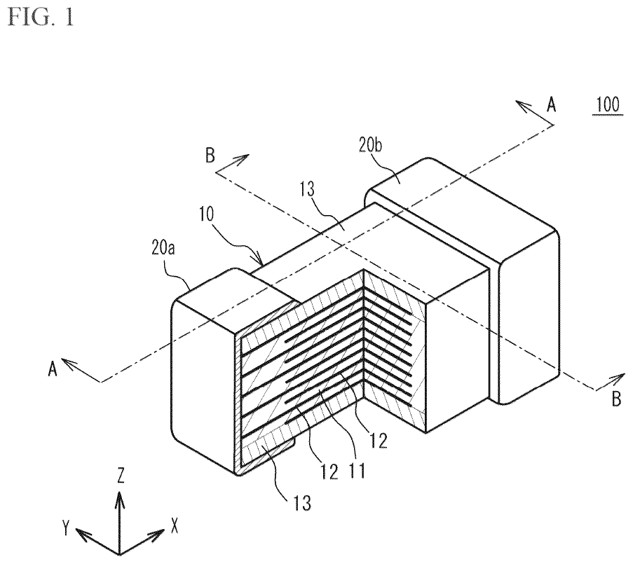

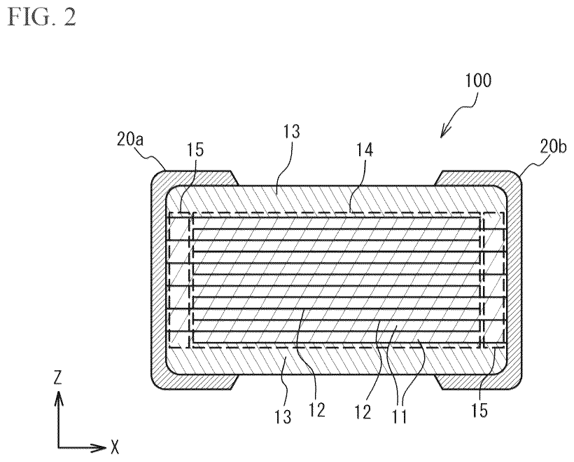

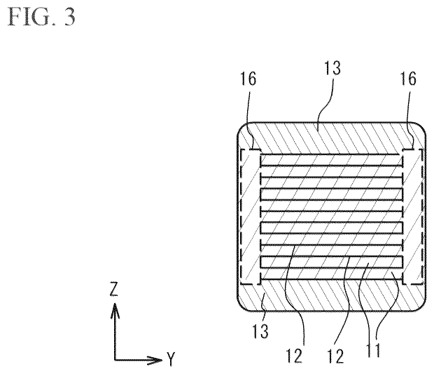

(Embodiment) FIG. 1 illustrates a perspective view of a multilayer ceramic capacitor 100, in which a cross section of a part of the multilayer ceramic capacitor 100 is illustrated. FIG. 2 is a cross-sectional view taken along line A-A in FIG. 1. FIG. 3 is a cross-sectional view taken along line B-B in FIG. 1. As illustrated in FIG. 1 to FIG. 3, the multilayer ceramic capacitor 100 includes an element body 10 having a rectangular parallelepiped shape, and external electrodes 20a and 20b that are respectively provided on two end faces of the element body 10 facing each other. Among four faces other than the two end faces of the element body 10, two faces other than the upper face and the lower face in the stacking direction are referred to as side faces. Each of the external electrodes 20a and 20b extends to the upper face and the lower face in the stacking direction and the two side faces of the element body 10. However, the external electrodes 20a and 20b are spaced from each other.

In FIG. 1 to FIG. 3, a Z-axis direction (first direction) is the stacking direction. The Z-axis direction is a direction in which internal electrode layers face each other. An X-axis direction (second direction) is a longitudinal direction of the element body 10. The X-axis direction is a direction in which the two end faces of the element body 10 are opposite to each other and in which the external electrode 20a is opposite to the external electrode 20b. A Y-axis direction (third direction) is a width direction of the internal electrode layers. The Y-axis direction is a direction in which the two side faces of the element body 10 are opposite to each other. The X-axis direction, the Y-axis direction and the Z-axis direction are orthogonal to each other.

The element body 10 has a structure designed to have dielectric layers 11 (dielectric ceramic composition) and internal electrode layers 12 alternately stacked. The dielectric layer 11 contains a ceramic material acting as a dielectric material. End edges of the internal electrode layers 12 are alternately exposed to a first end face of the element body 10 and a second end face of the element body 10 that is different from the first end face. The external electrode 20a is provided on the first end face. The external electrode 20b is provided on the second end face. Thus, the internal electrode layers 12 are alternately electrically connected to the external electrode 20a and the external electrode 20b. Accordingly, the multilayer ceramic capacitor 100 has a structure in which a plurality of the dielectric layers 11 are stacked with the internal electrode layers 12 interposed therebetween. In the multilayer structure of the dielectric layers 11 and the internal electrode layers 12, the outermost layers in the stack direction are the internal electrode layers 12, and cover layers 13 cover the top face and the bottom face of the multilayer structure. The cover layer 13 is mainly composed of a ceramic material. For example, the main component of the cover layer 13 may be the same as the main component of the dielectric layer 11 or may be different from the main component of the dielectric layer 11. Note that the configuration is not limited to those illustrated in FIG. 1 to FIG. 3, as long as the internal electrode layers 12 are exposed on two different surfaces and are electrically connected to different external electrodes.

For example, the multilayer ceramic capacitor 100 may have a length of 0.25 mm, a width of 0.125 mm, and a height of 0.125 mm. The multilayer ceramic capacitor 100 may have a length of 0.4 mm, a width of 0.2 mm, and a height of 0.2 mm. The multilayer ceramic capacitor 100 may have a length of 0.6 mm, a width of 0.3 mm, and a height of 0.3 mm. The multilayer ceramic capacitor 100 may have a length of 1.0 mm, a width of 0.5 mm, and a height of 0.5 mm. The multilayer ceramic capacitor 100 may have a length of 3.2 mm, a width of 1.6 mm, and a height of 1.6 mm. The multilayer ceramic capacitor 100 may have a length of 4.5 mm, a width of 3.2 mm, and a height of 2.5 mm. However, the size of the multilayer ceramic capacitor 100 is not limited to the above sizes.

The main component of the internal electrode layer 12 is not particularly limited, but is a base metal such as Ni (nickel), Cu (copper), Sn (tin). As a main component of the internal electrode layers 12, noble metals such as Pt (platinum), Pd (palladium), Ag (silver), Au (gold), and alloys containing these may be used. The internal electrode layer 12 may include a ceramic grain such as a co-material. The thickness of the internal electrode layers 12 is, for example, 5.0 μm or less, 3.0 μm or less, or 1.0 μm or less. The thickness of the internal electrode layers 12 can be measured by observing a cross section of the multilayer ceramic capacitor 100 with a scanning electron microscope (SEM), measuring the thickness at 10 points for each of 10 different internal electrode layers 12, and deriving the average value of all the measurement points.

A main component of the dielectric layer 11 is a ceramic material having a perovskite structure expressed by a general formula ABO₃. The perovskite structure includes ABO_{3-α} having an off-stoichiometric composition. For example, the ceramic material is such as BaTiO₃ (barium titanate), CaZrO₃ (calcium zirconate), CaTiO₃ (calcium titanate), SrTiO₃ (strontium titanate), MgTiO₃ (magnesium titanate), Ba_{1-x-y}CaₓSr_{y}Ti_{1-z}Zr_{z}O₃ (0≤x≤1, 0≤y≤1, 0≤z≤1) having a perovskite structure. Ba_{1-x-y}CaₓSr_{y}Ti_{1-z}Zr₂O₃ may be barium strontium titanate, barium calcium titanate, barium zirconate, barium titanate zirconate, calcium titanate zirconate, barium calcium titanate zirconate or the like. For example, the dielectric layers 11 contain 90 at % or more of the main component ceramic. The thickness of the dielectric layers 11 is, for example, 1 μm or more and 15 μm or less, 2 μm or more and 12 μm or less, or 3 μm or more and 10 μm or less. The thickness of the dielectric layers 11 can be measured by observing a cross section of the multilayer ceramic capacitor 100 with a scanning electron microscope (SEM), measuring the thickness at 10 points for each of the 10 different dielectric layers 11, and deriving the average value of all the measurement points.

Additives may be added to the dielectric layer 11. As additives to the dielectric layer 11, zirconium (Zr), hafnium (Hf), magnesium (Mg), manganese (Mn), molybdenum (Mo), vanadium (V), chromium (Cr), rare earth elements (yttrium (Y), samarium (Sm), europium (Eu), gadolinium (Gd), terbium (Tb), dysprosium (Dy), holmium (Ho), erbium (Er), thulium (Tm), and ytterbium (Yb)) or an oxide of cobalt (Co), nickel (Ni), lithium (Li), boron (B), sodium (Na), potassium (K) or silicon (Si), or a glass including cobalt, nickel, lithium, boron, sodium, potassium or silicon.

As illustrated in FIG. 2, the section where the internal electrode layers 12 connected to the external electrode 20a faces the internal electrode layers 12 connected to the external electrode 20b is a section where capacity is generated in the multilayer ceramic capacitor 100. Thus, this section is referred to as a capacity section 14. That is, the capacity section 14 is a section where two adjacent internal electrode layers 12 connected to different external electrodes face each other.

The section where the internal electrode layers 12 connected to the external electrode 20a face each other with no internal electrode layer 12 connected to the external electrode 20b interposed therebetween is referred to as an end margin 15. The section where the internal electrode layers 12 connected to the external electrode 20b face each other with no internal electrode layer 12 connected to the external electrode 20a interposed therebetween is also the end margin 15. That is, the end margin 15 is a section where the internal electrode layers 12 connected to one of the external electrodes face each other with no internal electrode layer 12 connected to the other of the external electrodes interposed therebetween. The end margin 15 is a section where no capacity is generated.

As illustrated in FIG. 3, in the element body 10, a side margin 16 is a section provided so as to cover the ends (ends in the Y-axis direction) of the two side faces of the dielectric layers 11 and the internal electrode layers 12. That is, the side margin 16 is a section provided outside the capacity section 14 in the Y-axis direction. The side margin 16 is also a section where no capacity is generated.

In the YZ cross section, the cover layer s13 and the side margins 16 form the outer periphery surrounding the capacity section 14. Therefore, hereinafter, the portion forming the outer periphery surrounding the capacity section 14 in the YZ cross section may be collectively referred to as an outer periphery. Note that the cover layer 13 refers to the portion of the outer periphery in the YZ cross section that is above the uppermost internal electrode layer 12 in the Y-axis direction. Therefore, the capacity section 14 and the pair of side margins are sandwiched between the two cover layers 13

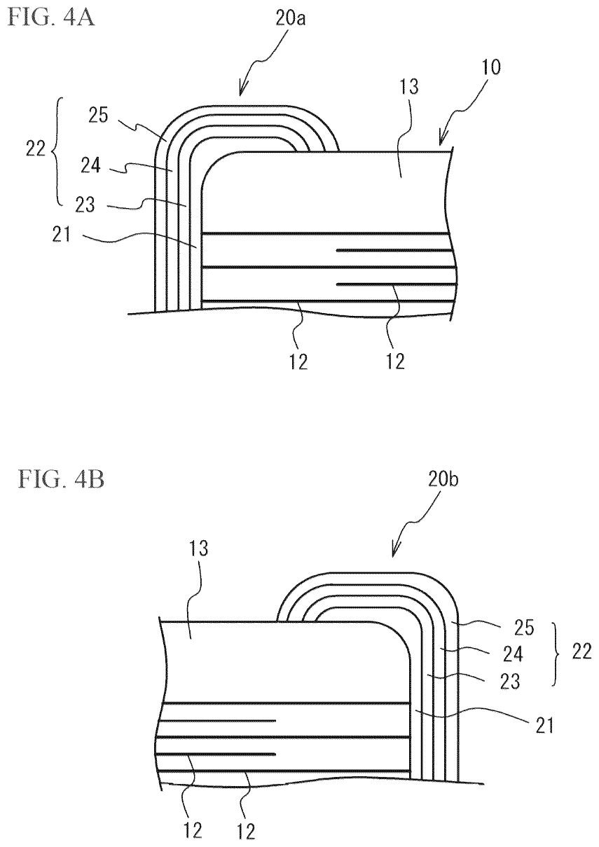

FIG. 4A is an enlarged cross-sectional view of the vicinity of the external electrode 20a. FIG. 4B is an enlarged cross-sectional view of the vicinity of the external electrode 20b. In FIG. 4A and FIG. 4B, hatches are omitted. As illustrated in FIG. 4A and FIG. 4B, the external electrodes 20a and 20b have a structure in which a plated layer 22 is provided on a base layer 21. The base layer 21 is primarily composed of nickel, copper, or the like. The base layer 21 may contain a ceramic grain or a glass component as a co-material. The plated layer 22 is primarily composed of a metal such as nickel, copper, aluminum, zinc, or tin, or an alloy of two or more of these metals. The plated layer 22 may be a plated layer of a single metal component or multiple plated layers of different metal components. For example, the plated layer 22 has a structure in which a first plated layer 23, a second plated layer 24, and a third plated layer 25 are formed in this order from the base layer 21 side. The first plated layer 23 is, for example, a copper plated layer. The second plated layer 24 is, for example, a nickel plated layer. The third plated layer 25 is, for example, a tin plated layer.

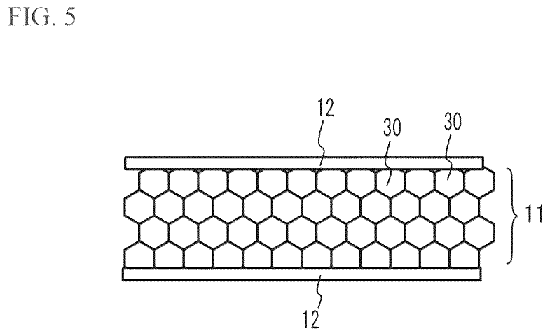

FIG. 5 is a schematic cross-sectional view of the dielectric layer 11. As illustrated in FIG. 5, the dielectric layer 11 has a structure in which a plurality of dielectric grains 30 that constitute the main phase are sintered. For example, the number of the dielectric grain 30 in the thickness direction in the dielectric layer 11 may be one. The dielectric layer 11 may have a structure in which the plurality of dielectric grains 30 are continuous through grain boundaries as

Here, we will examine the elements which are solid-dissolved in the dielectric grains 30. An oxide having a perovskite structure, such as barium titanate, is characterized by having two types of positions (sites) in the crystal where the cations are present. Sites occupied by +bivalent metal elements are called A sites, and sites occupied by +4valent metal elements are called B sites. The ion size of the A site is relatively large. Therefore, the A site tends to be mainly conformed to those with an ionic radius of 0.1 nm or more. The B sites tend to conform to relatively small ion sizes. When the metal element at A site and the metal element at B site have a total valence of +6, it becomes an ideal perovskite oxide with no vacancies.

However, when a base metal is used for the internal electrode layer, part of the +4-valent metal element becomes +3-valent during reduced firing at high temperature, and because of the 3d electrons of the +3-valent metal element, it exhibits high electrical conductivity, and furthermore, the concentration of oxide ion vacancies (sometimes called oxygen vacancies) increases due to the requirement for electrical neutral conditions. Therefore, a multilayer ceramic capacitor made using pure perovskite material may have low insulation after firing and poor reliability, making it difficult to withstand practical use.

When a rare earth element is ionized, the valence is usually +trivalent unless it is treated in a special atmosphere. Furthermore, the size of rare earth ions is smaller than the +divalent ions of the A site, but larger than the +divalent ions of the B site. Therefore, rare earth elements can be included in either the A-site or the B-site. When the A-site includes rare earth ions, the charge becomes excessively positive than the charge for the original site, and the rare earth ions become donors in terms of electronic structures, and electrons are fed into the band structure.

When rare earth ions are include in the B sites, the charge for the original site is shorter than the charge, and the rare earth ions become acceptors, and electrons are recovered and the concentration of oxide ion vacancies increases.

Adding rare earth elements that tend to be included in only the A sites in the perovskite structure after reduction firing, leads to conduction as a donor, as the concentration of oxide ion vacancies decreases but increases the concentration of electrons. When the rare earth elements are included in only the B-site of the perovskite structure in the state after reduction firing, the effect of the electron donor can be offset, but as compensation for the charge shortage, the concentration of the oxide ion vacancies is further increased, which is disadvantageous in reliability. However, if a single rare earth element that can be included in both the A and B sites, the rare earth element can be included in both of the sites at a certain ratio at the firing stage, and by canceling out the effects of the donor and acceptor, the formation of oxide ion vacancies and the rise in electron concentration can be suppressed. For this reason, among rare earth elements, only those with an affinity between the site A and the site B, and having an ion size within a limited range are used as additives, and it has been required to reduce electron and oxide ion vacancies by being included in both sites, and aim to improve reliability.

However, in the case of adding a single rare earth element, it is inevitable that the allocation of the A-site and the B-site as solid dissolution destinations is determined by the combination of various additives other than rare earth elements and firing conditions, and it is also possible that all rare earth elements added during firing have not reacted with the perovskite material and are not able to dissolve in solids. As a perovskite material used in multilayer ceramic capacitors, an additive other than rare earth elements is such as a fourth-period transition metal (vanadium to copper), a fifth-period transition metal (zirconium to silver), zinc, magnesium, aluminum, calcium, strontium, or the like. Furthermore, silicon is added in the form of silicon oxide (SiO₂) in order to form a liquid phase during sintering to contribute to improving sintering properties. Among these additives, transition metals in the fourth period, transition metals in the fifth period, zinc, magnesium, aluminum, calcium and strontium can easily be solid-dissolved in perovskite materials if cationized, but due to differences in chemical properties, silicon cannot be solid-dissolved in perovskite-type oxide crystals. On the other hand, since rare earth elements and silicon oxides can easily form silicates of rare earth elements, some of which were unable to solid-dissolve in the perovskite material during sintering with the added rare earth elements, after sintering, may remain as crystalline phases of impurities for the perovskite phase in the form of silicate salts of rare earth elements. Even additives other than rare earth elements that do not solid-dissolve in perovskite will similarly be present in the form of silicate crystals.

When adding rare earth elements, consider a method in which multiple types of rare earth elements are used consciously, and when doing so, the perovskite material is always used differently, suitable for the A-site and B-site. A rare earth element with a large ion size is prepared for the A-site, and a rare earth element with a small ion size is prepared for the B-site, and if the two types are cooperatively solid-dissolved in the A-site and the B-site, respectively, then both can be efficiently solid-dissolved in the perovskite material, and the total valence of the two rare earth element ions is +6, and since the donor and acceptor effects are just cancelled in the perovskite structural oxide, the formation of oxide ion vacancies and electron generation can be suppressed. When adding a single rare earth element, there is room for variation in the ratio of occupancy, whether it is the A site or the B site, depending on the difference in the firing temperature and the atmosphere of the firing, for example, and therefore the ideal solid solution of both sites may not always be achieved. However, if two types of rare earth elements with different site directivity, solid solution to both the site A and the B site can be expected in the desired manner, regardless of changes in the firing conditions.

If all additives other than silicon oxide react with perovskite, the structure that is completed after firing will be a phase of perovskite-based oxide grains and a phase that is roughly composed of silicon oxide. The phase consisting almost of silicon oxide is not a rare earth element silicate, but a segregated phase with silicon oxide as its main component. The main component of the segregated phase is silicon oxide, for example, means that the amount of silicon oxide in the segregated phase is 50 mol % or more.

For example, if the B site of the perovskite material is set to 100 mol %, the amount of silicon oxide added is about 2 mol % or less, and at most 5 mol % or less. Therefore, the volume is overwhelmingly greater than the perovskite type oxide grains, and the segregated phase, which is mainly composed of silicon oxide, is outside the grains of the perovskite material and is present at the grain boundaries.

When comparing metal oxides and silicon oxide, both contain oxygen atoms, but their bonding patterns are very different. It is well known that oxygen is ionized in metal oxide to form oxide ions O²⁻ and the vacancies can diffuse, and in fact, certain metal oxides have been practically used as ionic conductors. On the other hand, in silicon oxide, whether crystalline silicon oxide or glass is formed, oxygen and silicon form a strong covalent bond, and in order for oxygen to take the form of ions and diffuse, it must repeatedly cleavage and recombination of the strong covalent bond. Therefore, the diffusion of oxide ions in silicon oxide is very slow and almost never is observed clearly.

As a result, additives other than silicon oxide are incorporated into the oxide lattice to form a perovskite phase, and if silicon oxide is formed in a structure in which only silicon oxide remains at the outer grain boundaries of the oxide, the energy barrier when oxide ion vacancies diffuse across the grain boundaries increases, making it possible to suppress the movement speed of oxide ion defects as a whole material. As a result, the accumulation rate of oxide ion vacancies at the electrode-oxide interface upon application of voltage is slowed, and the Based on the above-mentioned results, the multilayer ceramic capacitor 100 according to this embodiment has a structure that can ensure reliability.

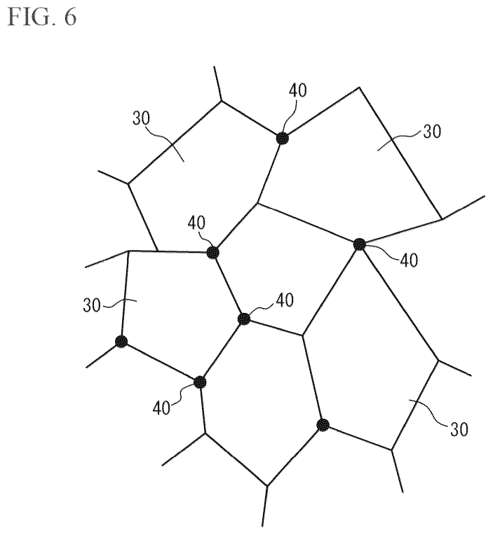

FIG. 6 is an enlarged cross-sectional view of the periphery of the dielectric grains 30. As illustrated in FIG. 6, three or more of the dielectric grains 30 form a grain boundary triple point. A grain boundary triple point is the boundary between three or more dielectric grains. A segregated phase 40, which is mainly composed of silicon oxide, is arranged at the grain boundary triple point.

The dielectric grains 30 include a first rare earth element with a large ionic radius and a second rare earth element with a smaller ionic radius than the first rare earth element. In this embodiment, at least one selected from lanthanum, cerium, praseodymium, neodymium, promethium, samarium, europium, and gadolinium is used as the first rare earth element. As the second rare earth element, at least one selected from yttrium, scandium, holmium, erbium, thulium, ytterbium, and lutetium is used.

Table 1 shows the ionic radii of six coordinations of each rare earth element. The source in Table 1 is “RD Shannon, Acta Crystallogr., A32, 751 (1976).”

TABLE 1

| | | IONIC RADIUS (Å) | |
|---|---|---|---|
| | VALENCE | 6-COORDINATION | 12-COORDINATION |
| Ba | 2-VALENT | | 1.610 |
| Ti | 4-VALENT | 0.605 | |
| Eu | 2-VALENT | 1.170 | |
| Dy | 2-VALENT | 1.070 | |
| La | 3-VALENT | 1.032 | |
| Tm | 2-VALENT | 1.030 | |
| Yb | 2-VALENT | 1.020 | |
| Ce | 3-VALENT | 1.010 | |
| Pr | 3-VALENT | 0.990 | |
| Nd | 3-VALENT | 0.983 | |
| Pm | 3-VALENT | 0.970 | |
| Sm | 3-VALENT | 0.958 | |
| Eu | 3-VALENT | 0.947 | |
| Gd | 3-VALENT | 0.938 | |
| Tb | 3-VALENT | 0.923 | |
| Dy | 3-VALENT | 0.912 | |
| Ho | 3-VALENT | 0.901 | |
| Y | 3-VALENT | 0.900 | |
| Er | 3-VALENT | 0.890 | |
| Tm | 3-VALENT | 0.880 | |
| Yb | 3-VALENT | 0.868 | |
| Lu | 3-VALENT | 0.861 | |
| Sc | 3-VALENT | 0.745 | |

Intensive research by the present inventors, it has been found that when the dielectric grains 30 include both the first rare earth element and the second rare earth element, and the elemental ratio (a ratio of a number of elements) between the first rare earth element and the second rare earth element is 65:35 to 35:65, a characteristic structure is created at the grain boundary of the dielectric grains 30, and that the segregated phase 40, which mainly contains silicon oxide, is placed at the grain boundary triple point of the dielectric grains 30, suppressing the movement of oxide ions. By suppressing the movement of oxide ions, the reliability of the dielectric layer 11 is ensured. Here, in the dielectric grains 30, when a plurality of types of lanthanum, cerium, praseodymium, neodymium, promethium, samarium, europium, and gadolinium are included as the first rare earth elements, the above-mentioned element number of the first rare earth elements is the sum of the above-mentioned element number of the first rare earth elements. In the dielectric grains 30, when a plurality of types of yttrium, scandium, holmium, erbium, thulium, ytterbium, and lutetium are included as the second rare earth elements, the element number of the second rare earth elements is the sum of the above-mentioned second rare earth elements.

The first rare earth element is not particularly limited as long as it is selected from lanthanum, cerium, praseodymium, neodymium, promethium, samarium, europium, and gadolinium, and the second rare earth element is not particularly limited as long as it is selected from yttrium, scandium, holmium, erbium, thulium, ytterbium, and lutetium, but it is preferred that europium be used as the first rare earth element and yttrium be used as the second rare earth element. The detailed mechanism is completely unknown, but since sintering and solid dissolution progress particularly quickly when europium and yttrium are combined, it is believed that a favorable effect can be easily obtained when fired under the same conditions.

If the content of the first rare earth element is too small compared to the content of the second rare earth element in the dielectric grains 30, reliability may be reduced. On the other hand, if the content of the first rare earth element is too large compared to the content of the second rare earth element, the insulation property may be insufficient and it may not be possible to use it as a dielectric. In this embodiment, the elemental ratio between the first rare earth element and the second rare earth element is preferably 60:40 to 40:60, more preferably 55:45 to 45:55.

If the total content of the first rare earth element and the second rare earth element in the dielectric grains 30 is too small, there is a risk that the A and B sites of the perovskite material do not sufficiently include the first rare earth element and the second rare earth element. Therefore, it is preferred that the dielectric grains 30 have a lower limit on the total content of the first rare earth element and the second rare earth element. In this embodiment, the total content of the first rare earth element and the second rare earth element in the dielectric grains 30 is preferably 1.5 mol % or more, more preferably 2.0 mol % or more, and even more preferably 3.0 mol % or more, when the content of the B-site metal elements such as titanium is 100 mol %.

On the other hand, if the total content of the first rare earth element and the second rare earth element in the dielectric grains 30 is too large, there is a risk that excessive decreases until the relative dielectric constant falls below 1,000. Therefore, it is preferred that the dielectric grains 30 have an upper limit on the total content of the first rare earth element and the second rare earth element. In this embodiment, the total content of the first rare earth element and the second rare earth element in the dielectric grains 30 is preferably 6.0 mol % or less, more preferably 5.0 mol % or less, and even more preferably 4.5 mol % or less, when the content of the B-site metal element such as titanium is 100 mol %.

If the amount of the segregated phase 40 is too small in the dielectric layer 11, there is a risk that the movement of oxide ion vacancies is sufficiently suppressed. Therefore, it is preferred to set a lower limit to the amount of the segregated phase 40 in the dielectric layer 11. In this embodiment, in a cross section of the dielectric layer 11 including the stacking direction, of the dielectric grains 30 included in the dielectric layer 11, it is preferred that any one of the segregated phases 40 contact the number of dielectric grains 30 of 50% or more, more preferably any one of the segregated phases 40 contact the number of dielectric grains 30 of 75% or more, and even more preferably any one of the segregated phases 40 contact the number of dielectric grains 30 of 90% or more.

Furthermore, in the cross section of the dielectric layer 11 including the stacking direction, the area ratio of the segregated phase 40 is preferably 0.1% or more, more preferably 0.5% or more, and even more preferably 1.0% or more. The area ratio of the segregated phase 40 is binarized to the SEM photograph to be the ratio of the total area of the black portion to the entire SEM photograph.

On the other hand, if the amount of the segregated phase 40 in the dielectric layer 11 is too large, the relative dielectric constant of the sintered body as a whole may be reduced, and the function of a dielectric may not be achieved. Therefore, it is preferred to set an upper limit on the amount of the segregated phase 40 in the dielectric layer 11. In this embodiment, in the cross section of the dielectric layer 11 including the stacking direction, the area ratio of the segregated phase 40 is preferably 10% or less, more preferably 5% or less, and even more preferably 3% or less.

If the segregated phase 40 is too small, there is a risk that the movement of oxide ions is not sufficiently suppressed. Therefore, it is preferred to set a lower limit on the average size of the segregated phases 40. In this embodiment, the average size of the segregated phase 40 is preferably 10 nm or more, more preferably 15 nm or more, and even more preferably 20 nm or more. The average size of the segregated phases 40 can be calculated from the average by binarizing an SEM photograph to calculate the diameter of a circle having an area equivalent to the area of each black part.

On the other hand, if the segregated phase 40 is too large, the relative dielectric constant of the sintered body as a whole may be reduced, making it difficult to obtain a function as a dielectric. Therefore, it is preferred to set an upper limit on the average size of the segregated phase 40. In this embodiment, the average size of the segregated phases 40 is preferably 200 nm or less, more preferably 150 nm or less, and even more preferably 100 nm or less.

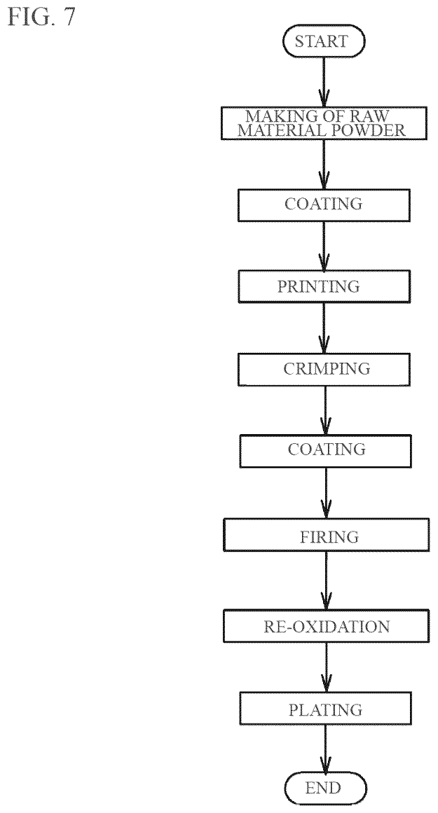

Next, a description will be given of a manufacturing method of the multilayer ceramic capacitors 100. FIG. 7 illustrates a manufacturing method of the multilayer ceramic capacitor 100.

(Making process of raw material powder) First, a dielectric material for forming the dielectric layer 11, a cover material for forming the cover layer 13, and a reverse pattern material for forming the side margin 16 are prepared. The dielectric material, the cover material, and the reverse pattern material contain barium titanate powder having a perovskite structure. For example, barium titanate is tetragonal compound having a perovskite structure and has a high dielectric constant. Generally, barium titanate is obtained by reacting a titanium material such as titanium dioxide with a barium material such as barium carbonate and synthesizing barium titanate. Various methods have been known for synthesizing barium titanate powder, such as the solid phase method, the sol-gel method, the hydrothermal method, etc. Any of these methods can be used in this embodiment.

The obtained barium titanate powder is added with a predetermined additive compound depending on the purpose to produce the dielectric material, the cover material, and the reverse pattern material, respectively. As the additive compound, zirconium, hafnium, magnesium, manganese, molybdenum, vanadium, chromium, rare earth elements (yttrium, samarium, europium, gadolinium, terbium, dysprosium, holmium, erbium, thulium, and ytterbium) or an oxide of cobalt, nickel, lithium, boron, sodium, potassium or silicon, or a glass including cobalt, nickel, lithium, boron, sodium, potassium or silicon. The oxides of the first and second rare earth elements may be added at the same time, but it is preferable that the particle size of the second rare earth element raw material be the same as or smaller than that of the first rare earth element raw material. Alternatively, a complex raw material can be used as the rare earth raw material. In this case, it is preferable to add the rare earth element later than the other additives, and more preferably add it last.

(Coating process) Next, a binder such as polyvinyl butyral (PVB) resin, an organic solvent such as ethanol or toluene, and a plasticizer are added to the obtained dielectric material and wet-mixed. Using the obtained slurry, a dielectric green sheet 51 is formed on the substrate by, for example, a die coater method or a doctor blade method, and dried. The substrate is, for example, polyethylene terephthalate (PET) film.

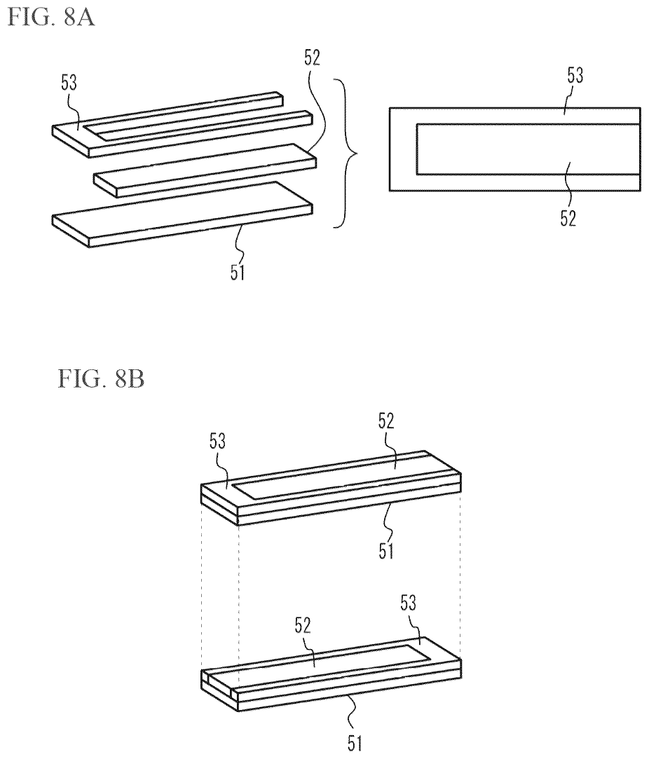

(Printing process) Next, as illustrated in FIG. 8A, a metal conductive paste for forming internal electrodes containing an organic binder is printed on the surface of the dielectric green sheet 51 by screen printing, gravure printing, or the like to form internal electrodes. Thus, an internal electrode pattern 52 for layers is arranged. Ceramic particles may be added to the metal conductive paste as a co-material. The main component of the ceramic particles is not limited. However, it is preferable that the main component of the ceramic particles is the same as the main component of the dielectric layer 11. For example, barium titanate having an average particle size of 50 nm or less may be uniformly dispersed.

Next, a binder such as ethyl cellulose and an organic solvent such as terpineol are added to the dielectric pattern material obtained in the making process of the raw material powder, and the mixture is kneaded in a roll mill to form a dielectric pattern paste for the reverse pattern layer. As illustrated in FIG. 8A, a dielectric pattern 53 is formed by printing the resulting slurry in the peripheral region, where the internal electrode pattern 52 is not printed, on the dielectric green sheet 51 to cause the dielectric pattern 53 and the internal electrode pattern 52 to form a flat surface. The dielectric green sheet 51 on which the internal electrode pattern 52 and the dielectric pattern 53 are printed is referred to as a stack unit.

Thereafter, as illustrated in FIG. 8B, a predetermined number of stack units are stacked so that the internal electrode layers 12 and the dielectric layers 11 are alternated with each other and the end edges of the internal electrode layers 12 are alternately exposed to both end faces in the length direction of the dielectric layer 11 so as to be alternately led out to a pair of the external electrodes 20a and 20b of different polarizations. In this embodiment, the number of the internal electrode pattern 52 is 100 to 1000.

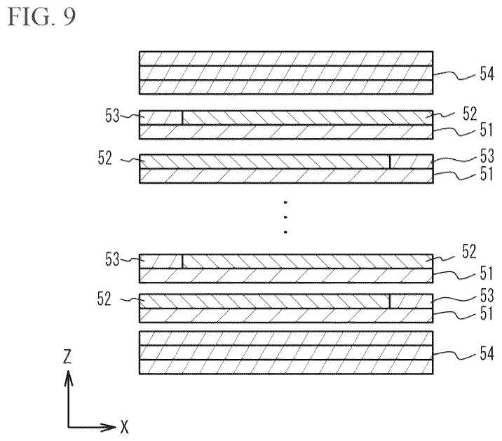

(Crimping process) Next, a binder such as an ethyl cellulose-based binder and an organic solvent such as a terpineol-based binder are added to the cover material and kneaded in a roll mill to obtain a cover sheet 54. As illustrated in FIG. 9, a predetermined number of the cover sheets 54 are stacked on top and bottom of a multilayer body in which the stack units are stacked, and then thermocompression bonded. The stack body is then cut to a predetermined chip size (for example, 1.0 mm×0.5 mm).

(Coating process) The binder is removed from the resulting ceramic multilayer body in N₂ atmosphere, normal atmosphere or the like. After that, a metal paste to be the base layer of the external electrodes 20a and 20b is applied to the resulting ceramic multilayer body by a dipping or the like.

(Firing process) After that, the mixture is subjected to a reduction atmosphere using a mixed N₂—H₂—H₂O gas, and the mixture is heated to 700° C. or more and 1000° C. or less at a rate of 100° C./h or more and 300° C./h or less and the mixture is held for 1 to 4 hours, and then debinding. After that, the temperature rise rate is increased to 100° C./h or more and 400° C./h or less and the temperature is increased to 1100° C. or more and 1300° C. or less, and the temperature is maintained for 0.1 to 4 hours, and the temperature is reduced to room temperature. The atmosphere at the time of firing may be the same as the atmosphere at the time of debinding, but if the H₂ ratio is increased compared to the time of debinding, sintering is promoted, more segregation can be formed.

(Re-oxidation process) Thereafter, a re-oxidation process may be performed in an N₂ gas atmosphere at 600 to 1000° C.

(Plating process) After that, metal layers such as copper, nickel, and tin may be formed on the external electrodes 20a and 20b by plating. Thus, the multilayer ceramic capacitor 100 is manufactured.

Note that in each of the above embodiments, a multilayer ceramic capacitor has been described as an example of a multilayer ceramic electronic device, but the present invention is not limited thereto. For example, other multilayer ceramic electronic devices such as varistors and thermistors may be used.

### EXAMPLE

Below, the multilayer ceramic capacitor according to the embodiment was fabricated and its characteristics were examined.

(Example 1) The amount of barium titanate prepared by the solid-phase synthesis method was 100 mol %, and europium was weighed to 1.8 mol % (0.9 mol % in the form of Eu₂O₃), yttrium was weighed to 1.8 mol % (0.9 mol % in the form of Y₂O₃), and silicon was weighed to 1.0 mol % (1.0 mol % in the form of SiO₂). Additionally, magnesium, vanadium, manganese and zirconium were added as additives. These mixed powders were dispersed with zirconia beads together with ethanol, toluene and a dispersant. After this dispersion, the slurry was passed through a filter to separate it from the zirconia beads, and then PVB (polyvinylbutyral) resin was mixed as a binder to obtain a slurry. Therefore, in Example 1, the elemental ratio between the first rare earth element and the second rare earth element was set to 50:50.

The thus obtained slurry was coated on the PET film with a die coater to form a 0.5 μm thick dielectric green sheet. After the dielectric green sheet was dried, nickel paste was printed to form an internal electrode pattern. Dielectric green sheets with an internal electrode pattern printed thereon were stacked. At this time, the positive electrode pattern and the negative electrode pattern were stacked so as to be alternating. A 50 μm dielectric layer of the same composition was stacked on top and bottom as a protective layer and was then heat-compression bonded. The plate-like compact body thus prepared was cut into individual pieces (chips) after sintering to a size of 1.0 mm×0.5 mm. Nickel paste was dipped onto two opposing surfaces of the chip after cutting, where the internal electrode lead portions were exposed, to form terminal electrodes.

The thus prepared chip was subjected to reduction atmosphere using a N₂—H₂—H₂O mixed gas, and then heated to 800° C. at 100° C./h, and then held for 2 hours, and subjected to debinding. After that, the temperature rise rate was increased to 200° C./h, and the temperature was increased to 1250° C., and then held for 2 hours, and then the temperature was decreased to room temperature. The thus-sintered chip was then subjected to a re-oxidation treatment at 800° C. in a dry N₂ atmosphere. Thus, a multilayer ceramic capacitor was obtained.

(Comparative Example 1) In Comparative Example 1, barium titanate prepared by the solid-phase synthesis method was weighed to 100 mol %, europium was weighed to 3.6 mol % (1.8 mol % in the form of Eu₂O₃) and silicon was weighed to 1.0 mol % (1.0 mol % in the form of SiO₂). Yttrium was not used. The other conditions were the same as in Example 1.

(Comparative Example 2) In Comparative Example 2, barium titanate prepared by the solid-phase synthesis method was weighed to 100 mol %, yttrium was weighed to 3.6 mol % (1.8 mol % in the form of Y₂O₃) and silicon was weighed to 1.0 mol % (1.0 mol % in the form of SiO₂). No europium was used. The other conditions were the same as in Example 1.

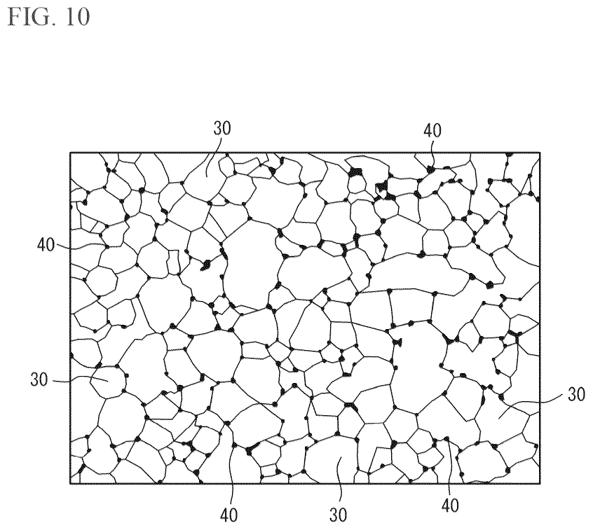

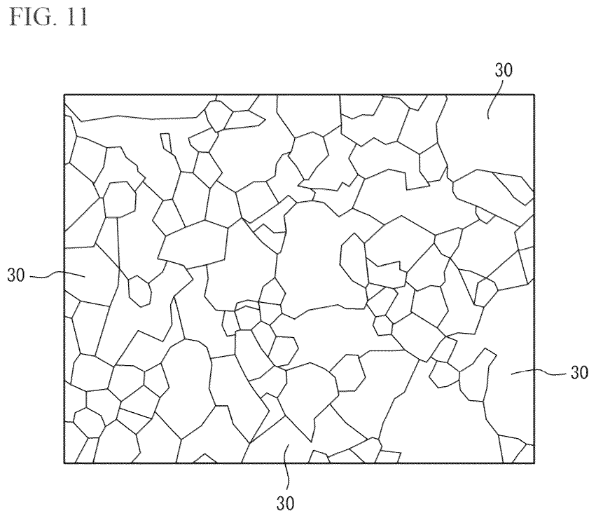

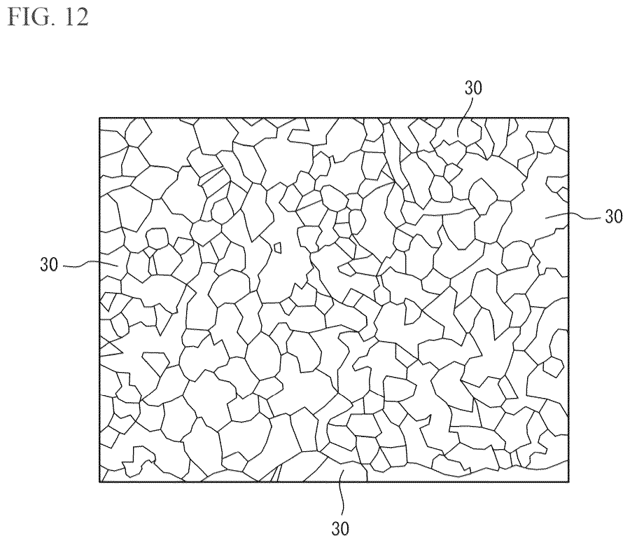

(Whether or not there is a segregated phase) For each of the samples of Example 1 and Comparative Examples 1 and 2, BSE images (scattered electron images) of the cross-section of the dielectric layer were obtained. FIG. 10 is a diagram of a trace of the BSE image of the sample of Example 1. FIG. 11 is a diagram of a trace of the BSE image of the sample of Comparative Example 1. FIG. 12 is a diagram of a trace of the BSE image of the sample of Comparative Example 2.

As illustrated in FIG. 10, in the sample of Example 1, the segregated phase 40 (black part in FIG. 10) with silicon oxide as the main component was confirmed at the triple point of the dielectric grains of the main phase. This is thought to be because europium was used as the first rare earth element and yttrium was used as the second rare earth element, and the elemental ratio between the first rare earth element and the second rare earth element was set to 50:50. In contrast, in the samples of Comparative Examples 1 and 2, no segregated phase with silicon oxide as the main component was confirmed. This is thought to be because only one of the first rare earth element or the second rare earth element was used.

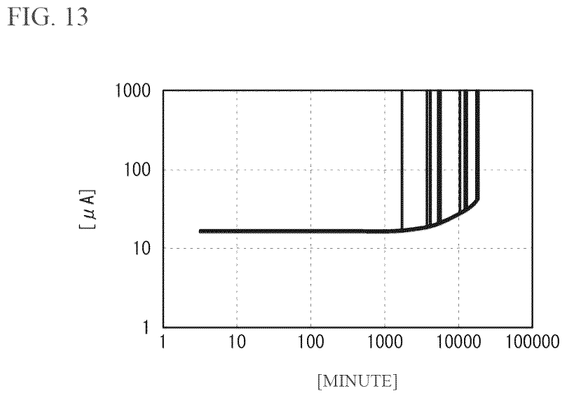

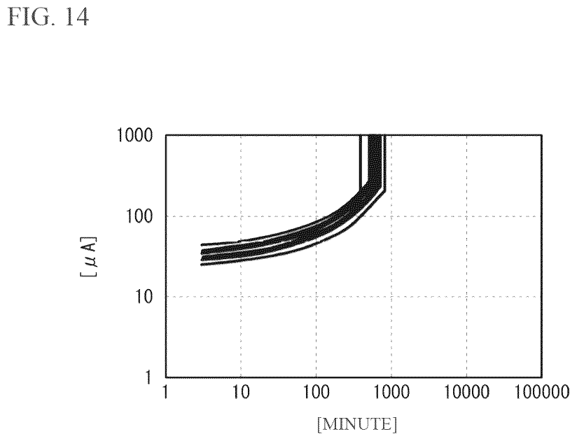

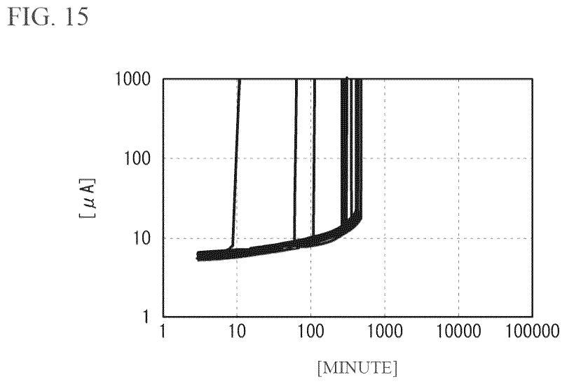

(Reliability test) Subsequently, reliability tests were performed on 10 samples for each of Example 1 and Comparative Examples 1 and 2. In the reliability test, the behavior leading to dielectric breakdown when a voltage of 50 V per μm was continuously applied at a temperature of 150° C. was examined. FIG. 13 shows the results of Example 1, FIG. 14 shows the results of Comparative Example 1, and FIG. 15 shows the results of Comparative Example 2. In all of FIG. 13 to FIG. 15, the horizontal axis indicates the elapsed time (minutes), and the vertical axis indicates the current (μA).

If the average life time is 1,000 minutes or more, the reliability test was judged as acceptable “o”, and if not, it was judged as unacceptable “x”.

As shown in FIG. 13, in Example 1, the average time until dielectric breakdown was about 10,000 minutes, and the maximum time was 19,000 minutes. Therefore, in Example 1, the reliability test was judged as acceptable “o”. This gives the surprising result that sufficient reliability was obtained in Example 1. This can be thought to be because the segregated phase, which mainly contains silicon oxide, was placed at the triple point of the dielectric grains, suppressing the movement of oxide ions.

On the other hand, as shown in FIG. 14, in Comparative Example 1, the average time until dielectric breakdown was about 600 minutes, and the maximum time was about 900 minutes. Furthermore, as shown in FIG. 15, in Comparative Example 2, the average time until the dielectric breakdown was about 300 minutes, and the maximum time was 500 minutes. Therefore, in Comparative Examples 1 and 2, the reliability test was judged as unacceptable “x”. From these results, it can be considered that this is because in Comparative Examples 1 and 2, the segregated phase, which mainly contains silicon oxide, did not segregate, and therefore the movement of oxide ions was not suppressed. These results are shown in Table 2.

TABLE 2

| | FIRST RARE | | SECOND RARE | | | | |
|---|---|---|---|---|---|---|---|
| | EARTH ELEMENT | | EARTH ELEMENT | | | AVERAGE | |
| | | ADDED | | ADDED | | LIFE | |
| | | AMOUNT | | AMOUNT | SEGREGATED | TIME | |
| | ELEMENT | (mol %) | ELEMENT | (mol %) | PHASE | (MINUTE) | RELIABILITY |
| EXAMPLE 1 | Eu | 1.8 | Y | 1.8 | PRESENT | 10,000 | ∘ |
| COMPARATIVE | Eu | 3.6 | — | — | ABSENT | 600 | x |
| EXAMPLE 1 | | | | | | | |
| COMPARATIVE | — | — | Y | 3.6 | ABSENT | 300 | x |
| EXAMPLE 2 | | | | | | | |

(Example 2) In Example 2, barium titanate prepared by the solid-phase synthesis method was made into 100 mol %, gadolinium was weighed to 2.34 mol % (1.17 mol % in the form of Gd₂O₃), yttrium was weighed to 1.26 mol % (0.63 mol % in the form of Y₂O₃), and silicon was weighed to 1.0 mol % (1.0 mol % in the form of SiO₂). Therefore, the elemental ratio between the first rare earth element and the second rare earth element was set to 65:35. The other conditions were the same as in Example 1.

(Example 3) In Example 3, barium titanate prepared by the solid-phase synthesis method was made into 100 mol %, gadolinium was weighed to 1.8 mol % (0.9 mol % in the form of Gd₂O₃), yttrium was weighed to 1.8 mol % (0.9 mol % in the form of Y₂O₃), and silicon was weighed to 1.0 mol % (1.0 mol % in the form of SiO₂). Therefore, the elemental ratio between the first rare earth element and the second rare earth element was set to 50:50. The other conditions were the same as in Example 1.

(Example 4) In Example 4, barium titanate prepared by the solid-phase synthesis method was made into 100 mol %, gadolinium was weighed to 1.26 mol % (0.63 mol % in the form of Gd₂O₃), yttrium was weighed to 2.34 mol % (1.17 mol % in the form of Y₂O₃), and silicon was weighed to 1.0 mol % (1.0 mol % in the form of SiO₂). Therefore, the elemental ratio between the first rare earth element and the second rare earth element was set to 35:65. The other conditions were the same as in Example 1.

(Example 5) In Example 5, barium titanate prepared by the solid-phase synthesis method was made into 100 mol %, europium was weighed to 2.34 mol % (1.17 mol % in the form of Eu₂O₃), yttrium was weighed to 1.26 mol % (0.63 mol % in the form of Y₂O₃), and silicon was weighed to 1.0 mol % (1.0 mol % in the form of SiO₂). Therefore, the elemental ratio between the first rare earth element and the second rare earth element was set to 65:35. The other conditions were the same as in Example 1.

(Example 6) In Example 6, barium titanate prepared by the solid-phase synthesis method was made as 100 mol %, europium was weighed to 1.26 mol % (0.63 mol % in the form of Eu₂O₃), 2.34 mol % (1.17 mol % in the form of Y₂O₃), and silicon was weighed to 1.0 mol % (1.0 mol % in the form of SiO₂). Therefore, the elemental ratio between the first rare earth element and the second rare earth element was set to 35:65. The other conditions were the same as in Example 1.

(Example 7) In Example 7, barium titanate prepared by the solid-phase synthesis method was made into 100 mol %, lanthanum was weighed to 1.8 mol % (0.9 mol % in the form of La₂O₃), yttrium was weighed to 1.8 mol % (0.9 mol % in the form of Y₂O₃), and silicon was weighed to 1.0 mol % (1.0 mol % in the form of SiO₂). Therefore, the elemental ratio between the first rare earth element and the second rare earth element was set to 50:50. The other conditions were the same as in Example 1.

(Example 8) In Example 8, barium titanate prepared by the solid-phase synthesis method was made into 100 mol %, neodymium was weighed to 1.8 mol % (0.9 mol % in the form of Nd₂O₃), yttrium was weighed to 1.8 mol % (0.9 mol % in the form of Y₂O₃), and silicon was weighed to 1.0 mol % (1.0 mol % in the form of SiO₂). Therefore, the elemental ratio between the first rare earth element and the second rare earth element was set to 50:50. The other conditions were the same as in Example 1.

(Example 9) In Example 9, barium titanate prepared by the solid-phase synthesis method was made into 100 mol %, gadolinium was weighed to 1.8 mol % (0.9 mol % in the form of Gd₂O₃), scandium was weighed to 1.8 mol % (0.9 mol % in the form of Sc₂O₃), and silicon was weighed to 1.0 mol % (1.0 mol % in the form of SiO₂). Therefore, the elemental ratio between the first rare earth element and the second rare earth element was set to 50:50. The other conditions were the same as in Example 1.

(Example 10) In Example 10, barium titanate prepared by the solid-phase synthesis method was made into 100 mol %, europium was weighed to 1.8 mol % (0.9 mol % in the form of Eu₂O₃), scandium was weighed to 1.8 mol % (0.9 mol % in the form of Sc₂O₃), and silicon was weighed to 1.0 mol % (1.0 mol % in the form of SiO₂). Therefore, the elemental ratio between the first rare earth element and the second rare earth element was set to 50:50. The other conditions were the same as in Example 1.

(Example 11) In Example 11, barium titanate prepared by the solid-phase synthesis method was made into 100 mol %, gadolinium was weighed to 1.8 mol % (0.9 mol % in the form of Gd₂O₃), holmium was weighed to 1.8 mol % (0.9 mol % in the form of Ho₂O₃), and silicon was weighed to 1.0 mol % (1.0 mol % in the form of SiO₂). Therefore, the elemental ratio between the first rare earth element and the second rare earth element was set to 50:50. The other conditions were the same as in Example 1.

(Example 12) In Example 12, barium titanate prepared by the solid-phase synthesis method was made into 100 mol %, gadolinium was weighed to 1.8 mol % (0.9 mol % in the form of Gd₂O₃), holmium was weighed to 1.8 mol % (0.9 mol % in the form of Ho₂O₃), and silicon was weighed to 1.0 mol % (1.0 mol % in the form of SiO₂). Therefore, the elemental ratio between the first rare earth element and the second rare earth element was set to 40:60. The other conditions were the same as in Example 1.

(Example 13) In Example 13, barium titanate prepared by the solid-phase synthesis method was made as 100 mol %, gadolinium was weighed to 1.8 mol % (0.9 mol % in the form of Gd₂O₃), ytterbium was weighed to 1.8 mol % (0.9 mol % in the form of Y₂O₃), and silicon was weighed to 1.0 mol % (1.0 mol % in the form of SiO₂). Therefore, the elemental ratio between the first rare earth element and the second rare earth element was set to 50:50. The other conditions were the same as in Example 1.

(Comparative Example 3) In Comparative Example 3, barium titanate prepared by the solid-phase synthesis method was weighed to be 100 mol %, terbium was weighed to be 1.8 mol % (0.9 mol % in the form of Tb₂O₃), ytterbium was weighed to be 1.8 mol % (0.9 mol % in the form of Y₂O₃), and silicon was weighed to be 1.0 mol % (1.0 mol % in the form of SiO₂). Therefore, the elemental ratio between the first rare earth element and the second rare earth element was set to 50:50. The other conditions were the same as in Example 1.

(Comparative Example 4) In Comparative Example 4, barium titanate prepared by the solid-phase synthesis method was made as 100 mol %, and dysprosium was weighed to 1.8 mol % (0.9 mol % in the form of Dy₂O₃), ytterbium was weighed to 1.8 mol % (0.9 mol % in the form of Y₂O₃), and silicon was weighed to 1.8 mol % (1.8 mol % in the form of SiO₂). Therefore, the elemental ratio between the first rare earth element and the second rare earth element was set to 50:50. The other conditions were the same as in Example 1.

(Comparative Example 5) In Comparative Example 5, barium titanate prepared by the solid-phase synthesis method was made as 100 mol %, dysprosium was weighed to 1.8 mol % (0.9 mol % in the form of Dy₂O₃), holmium was weighed to 1.8 mol % (0.9 mol % in the form of Ho₂O₃), and silicon was weighed to 1.0 mol % (1.0 mol % in the form of SiO₂). Therefore, the elemental ratio between the first rare earth element and the second rare earth element was set to 50:50. The other conditions were the same as in Example 1.

(Comparative Example 6) In Comparative Example 6, barium titanate prepared by the solid-phase synthesis method was made as 100 mol %, gadolinium was weighed to 1.8 mol % (0.9 mol % in the form of Gd₂O₃), dysprosium was weighed to 1.8 mol % (0.9 mol % in the form of Dy₂O₃), and silicon was weighed to 1.0 mol % (1.0 mol % in the form of SiO₂). Therefore, the elemental ratio between the first rare earth element and the second rare earth element was set to 50:50. The other conditions were the same as in Example 1.

(Comparative Example 7) In Comparative Example 7, barium titanate prepared by the solid-phase synthesis method was weighed to 100 mol %, neodymium was weighed to 3.6 mol % (1.8 mol % in the form of Nd₂O₃) and silicon was weighed to 1.0 mol % (1.0 mol % in the form of SiO₂). No second rare earth elements were used. The other conditions were the same as in Example 1.

(Comparative Example 8) In Comparative Example 8, barium titanate prepared by the solid-phase synthesis method was weighed to 100 mol %, gadolinium was weighed to 3.6 mol % (1.8 mol % in the form of Gd₂O₃) and 1.0 mol % (1.0 mol % in the form of SiO₂). No second rare earth elements were used. The other conditions were the same as in Example 1.

(Whether or not there is a segregated phase) For each of the samples of Examples 2-13 and Comparative Examples 3-8, BSE images (scattered electron images) of the cross-section of the dielectric layer were obtained, and the presence or absence of the segregated phase 40 was confirmed. In all of Examples 2 to 13, the segregated phase 40 with silicon oxide as the main component was confirmed at the triple point of the dielectric grains of the main phase. This is thought to be because any of lanthanum, cerium, praseodymium, neodymium, promethium, samarium, europium or gadolinium is used as the first rare earth element, and any of yttrium, scandium, holmium, erbium, thulium, ytterbium or lutetium is used as the second rare earth element, and the elemental ratio between the first rare earth element and the second rare earth element was set to 65:35 or 35:65.

In contrast, in the samples of Comparative Examples 3 to 8, no segregated phase with silicon oxide as the main component was confirmed. This is thought to be because terbium was used as the first rare earth element in Comparative Example 3, dysprosium was used as the first rare earth element in Comparative Examples 4 and 5, dysprosium was used as the second rare earth element in Comparative Examples 6, and only the first rare earth element was used in Comparative Examples 7 and 8.

(Reliability test) Next, as in Example 1, 10 samples were subjected to reliability tests for each of Examples 2 to 13 and Comparative Examples 3 to 8. The average life time up to dielectric breakdown was 4,500 minutes in Example 2, 10,000 minutes in Example 3, 5,500 minutes in Example 4, 5,500 minutes in Example 5, 7,500 minutes in Example 6, 1,100 minutes in Example 7, 1,800 minutes in Example 8, 1,200 minutes in Example 9, 1,300 minutes in Example 10, 4,500 minutes in Example 11, 2,800 minutes in Example 12, 1,300 minutes in Example 13, 300 minutes in Comparative Example 3, 600 minutes in Comparative Example 4, 800 minutes in Comparative Example 5, 0 minutes in Comparative Example 6, 0 minutes in Comparative Example 7, and 0 minutes in Comparative Example 8.

Therefore, the reliability tests for all of Examples 2 to 13 were judged as acceptable “o”. This gives the surprising results that sufficient reliability was obtained in Examples 2-13. This can be thought to be because the segregated phase, which mainly contains silicon oxide, was placed at the triple point of the dielectric grains, suppressing the movement of oxide ions.

In contrast, in Comparative Examples 2 to 8, the reliability test was judged as unacceptable “x”. From these results, it can be considered that this is because in Comparative Examples 2 to 8, the segregated phase, which mainly contains silicon oxide, did not segregate, and therefore the movement of oxide ions was not suppressed. These results are shown in Table 3.

TABLE 3

| | | SECOND | | | AVERAGE | |
|---|---|---|---|---|---|---|
| | FIRST RARE | RARE | | | LIFE | |
| | EARTH | EARTH | MIXING | SEGREGATED | TIME | |
| | ELEMENT | ELEMENT | RATIO | PHASE | (MINUTE) | RELIABILITY |
| EXAMPLE 2 | Gd | Y | 65:35 | PRESENT | 4500 | ∘ |
| EXAMPLE 3 | Gd | Y | 50:50 | PRESENT | 10000 | ∘ |
| EXAMPLE 4 | Gd | Y | 35:65 | PRESENT | 5500 | ∘ |
| EXAMPLE 5 | Eu | Y | 65:35 | PRESENT | 5500 | ∘ |
| EXAMPLE 6 | Eu | Y | 35:65 | PRESENT | 7500 | ∘ |
| EXAMPLE 7 | La | Y | 50:50 | PRESENT | 1100 | ∘ |
| EXAMPLE 8 | Nd | Y | 50:50 | PRESENT | 1800 | ∘ |
| EXAMPLE 9 | Gd | Sc | 50:50 | PRESENT | 1200 | ∘ |
| EXAMPLE 10 | Eu | Sc | 50:50 | PRESENT | 1300 | ∘ |
| EXAMPLE 11 | Gd | Ho | 50:50 | PRESENT | 4500 | ∘ |
| EXAMPLE 12 | Gd | Ho | 40:60 | PRESENT | 2800 | ∘ |
| EXAMPLE 13 | Gd | Yb | 50:50 | PRESENT | 1300 | ∘ |
| COMPARATIVE | Tb | Y | 50:50 | ABSENT | 300 | x |
| EXAMPLE 3 | | | | | | |
| COMPARATIVE | Dy | Y | 50:50 | ABSENT | 600 | x |
| EXAMPLE 4 | | | | | | |
| COMPARATIVE | Dy | Ho | 50:50 | ABSENT | 800 | x |
| EXAMPLE 5 | | | | | | |
| COMPARATIVE | Gd | Dy | 50:50 | ABSENT | 0 | x |
| EXAMPLE 6 | | | | | | |
| COMPARATIVE | Nd | — | | ABSENT | 0 | x |
| EXAMPLE 7 | | | | | | |
| COMPARATIVE | Gd | — | | ABSENT | 0 | x |
| EXAMPLE 8 | | | | | | |

Although the embodiments of the present invention have been described in detail, it is to be understood that the various changes, substitutions, and alterations could be made hereto without departing from the spirit and scope of the invention.

1. A multilayer ceramic electronic device comprising:
a dielectric layer which includes a plurality of dielectric grains each of which includes a first rare earth element which is at least one selected from lanthanum, cerium, praseodymium, neodymium, promethium, samarium, europium or gadolinium and a second rare earth element which is at least one selected from yttrium, scandium, holmium, erbium, thulium, ytterbium or lutetium, in which an elemental ratio of the first rare earth element and the second rare earth element is from 65:35 to 35:65, and segregated phases mainly composed of silicon oxide are located at least one grain boundary triple point of the plurality of dielectric grains;
a plurality of internal electrode layers which sandwich the dielectric layer and face each other; and
external electrodes each of which is electrically connected to each of the plurality of internal electrode layers.

2. The multilayer ceramic electronic device as claimed in claim 1,
wherein 50% or more of the plurality of dielectric grains contact to at least one of the segregated phases.

3. The multilayer ceramic electronic device as claimed in claim 1,
wherein an average size of the segregated phases is 10 nm or more.

4. The multilayer ceramic electronic device as claimed in claim 1,
wherein an amount of the first rare earth element and the second rare earth element in the plurality of dielectric grains is 1.5 mol % or more and 6.0 mol % or less.

5. The multilayer ceramic electronic device as claimed in claim 1,
wherein the first rare earth element is europium, and the second rare earth element is yttrium.

6. The multilayer ceramic electronic device as claimed in claim 1,
wherein a main component of the plurality of dielectric grains is a ceramic material having a perovskite structure.

7. The multilayer ceramic electronic device as claimed in claim 6,
wherein the ceramic material is barium titanate.

8. A dielectric ceramic composition comprising:
a plurality of dielectric grains each of which includes a first rare earth element which is at least one selected from lanthanum, cerium, praseodymium, neodymium, promethium, samarium, europium or gadolinium and a second rare earth element which is at least one selected from yttrium, scandium, holmium, erbium, thulium, ytterbium or lutetium,
wherein an elemental ratio of the first rare earth element and the second rare earth element is from 65:35 to 35:65, and
wherein segregated phases mainly composed of silicon oxide are located at least one grain boundary triple point of the plurality of dielectric grains.
